(19) United States
(12) Patent Application Publication
(10) Pub. No.: US 2026/0263845 A1
(43) Pub. Date: Sep. 10, 2026

(54) DEVICE FOR HEIGHT SAFETY AND/OR PROTECTION AGAINST FALLS

(71) Applicant: SPANSET INTER AG, Wollerau (CH)

(72) Inventors: Reto BUSER, Gunzgen (CH); Michael GRISSEMANN, Wetzikon (CH); André MAMIÉ, Wädenswil (CH)

(21) Appl. No.: 19/165,898

(22) PCT Filed: Feb. 20, 2024
(86) PCT No.: PCT/EP2024/054232

§ 371 Date: Sep. 16, 2025

(30) Foreign Application Priority Data
Mar. 17, 2023 (DE) 10 2023 001 064.2

(51) Int. Cl. A62B 35/00; A62B 35/04

(52) U.S. Cl. CPC A62B 35/0068; A62B 35/04

(57) ABSTRACT

The invention relates to a device for height safety and/or protection against falls in the form of a davit arm comprising a base that has a defined weight that is many times greater than that of the davit arm itself, wherein the davit arm, acting as a crane element, substantially consists of a rod element and a cross arm, and a plurality of damping elements are provided on the cross arm.

### BACKGROUND OF THE INVENTION

### Field of the Invention

The invention relates to a device for height safety and/or protection against falls in the form of a davit arm comprising a base that has a defined weight that is many times greater than that of the davit arm.

### Background Art

Such devices for height safety and/or protection against falls are already known, for example from EP 1 400 642 A1. Therein, a davit arm is disclosed in which a cross arm is rigidly arranged. Though this cross arm is mounted to be rotatable around a vertical axis of the device, the device has to be inserted with its base into a support surface and locked there. The rigid arrangement ensures that there is no unsecured, free installation of base on a support surface.

Furthermore, other devices for height safety and/or protection against falls are known, such as those disclosed in US 20140008511 A1 or EP 3 825 493 A1. A damping element is disclosed there that supports the cross arm and deforms in the direction of the support surface when the cross arm is subjected to tensile stress, thus pushing it together.

A common feature of all of the devices described above is that a fixed ring-shaped device is connected to one free end of the cross arm, to which a flexible sling, such as a holding rope, can be attached, to which a person to be secured can be attached by means of known locking means.

However, when subjected to tensile stress, considerable forces act on this free end, which, due to the lever action of the cross arm, can cause the davit arm to be stressed at its base to the extent that it gets damaged. In any case, the known configuration is not sufficient to ensure that the devices can be set up freely without a form-fitting and/or force-fitting attachment to a support surface in a functionally secure manner.

### SUMMARY OF THE INVENTION

The object of the invention is to improve the disadvantages of the prior art, in particular provide an optimized device for height safety and/or protection against falls, in which the base does not have to be locked to the support surface by a form-fitting and/or force-fitting attachment in order to ensure the functional safety of the device.

The object is achieved according to the invention by a device for height safety and/or protection against falls having the features of Claim 1. Advantageous embodiments of the invention are specified in the subclaims.

The device according to the invention for height safety and/or protecting people against falls consists of at least one mobile davit arm as a crane element with a base. The base is intended to be placed on a support surface, for example horizontal surfaces such as horizontal roof surfaces, horizontal parts of buildings such as floor slabs or surfaces close to the ground, or even temporary platforms such as slab formwork and other scaffolding-like structures.

Furthermore, the base has a defined weight. The base can be, for example, a cuboid element with a mount for the crane element. The mount is located on an upper side of the base opposite the support surface.

Within the meaning of the invention the base can also be just the mount itself, for example a sleeve element that is arranged in or on a building structure, for example, connected to the building structure in a form-fitting and force-fitting manner, i.e. screwed or materially bonded, or set in concrete. The crane element is inserted into the mount to be functionally secure, lockable and removable. As a rule, a detachable connection is provided between the base and the crane element. Any known connections can be used within the scope of the invention.

The crane element has an upright rod element, at the free end of which a cross arm is arranged, which can be pivoted at a variable angle α to the rod element and can be pivoted relative to the rod element in a plane to change the angle α. For example, the angle α can be a right angle.

Within the meaning of the invention, in the region of the free end of the rod element is also defined as the free end of the rod element.

An exact arrangement at this free end is not necessary for the invention. The region of the free end is included, as the device can also be sufficiently effective there.

Furthermore, the crane element has a first damping element which is arranged on the rod element and the cross arm such that the first damping element can counteract a supporting movement of the cross arm in the direction of the base, a change in the angle α, and/or can allow a change in the angle α by means of plastic deformation.

The cross arm and the first damping element are arranged to be radially rotatable at the free end of the rod element by means of at least one bearing. This allows a rotational movement relative to the rod element about its vertical axis.

According to the invention, a further damping element, which can counteract an extension movement or a pulling movement in the longitudinal extension of the cross arm, a so-called tension damper, is arranged on the cross arm at another free end of the cross arm. At least one flexible stop means, for example a holding rope, can be arranged on the further damping element. A person to be secured can then be attached to the holding rope. The holding rope is therefore used to secure a person against falling.

The other free end of the cross arm is also defined within the meaning of the invention as in the region of the other free end of the cross arm. An exact arrangement at this other free end is not necessary for the invention. The region of the other free end is also included, as the device can also be sufficiently effective there. The arrangement can therefore also be movable to a limited degree in the longitudinal direction of the cross arm at the other free end of the cross arm.

The base can be made of concrete or a comparable material, for example. If the base is the mount, it is made of a suitable metal or plastic. As a davit arm the crane element is made of metal, for example a steel alloy commonly used for this purpose.

Within the scope of the invention the bearing described above can be configured as a bearing element that has at least one bearing shell and is arranged to be radially rotatable at the free end of the rod element, and the cross arm and the first damping element are arranged on the bearing element. This allows the cross arm and the first damping element to rotate together around the longitudinal axis of the rod element without the rod element rotating in the mount.

In a further embodiment of the invention, the first damping element can be arranged to be axially displaceable on the cross arm, which allows the angle α to be easily adjusted.

In this case, the first damping element is detachably arranged on the cross arm, wherein a grid pattern arrangement can be formed by means of a known screw or plug connection. It may also be provided that the first damping element is axially displaceable on the cross arm by means of a clamping element. This allows a defined fine adjustment of the angle α.

In a further embodiment of the invention, it may be provided that the further damping element is integrated into the cross arm, for example, is inserted in the latter to be functionally secure but with a detachable connection. This allows for improved force absorption and force dissipation.

The further damping element can be held in any suitable and known technical configuration, for example as a hydraulic damper or as a damper acted upon by spring force. In the latter configuration, the damping element has at least one spring element, wherein the at least one spring element is a coil spring.

The additional damping element can also be configured as a plastically deformable component, in which a damping effect is achieved by deformation through bending or deformation of two further components that interact by means of a press fit. Also within the scope of the invention, a tear strip made of metal and/or textile fabric can be considered as an additional damping element.

As already mentioned, the base can have different configurations. It can be provided that the defined weight of the base is many times greater than the weight of the crane element. The base is then a kind of anchor, wherein the base is arranged on the support surface without a form-fitting and/or force-fitting attachment thereto. It can be easily and simply set up without fastening means and then put into use. The defined weight of the base can, for example, be greater than or equal to 500 kg and the weight of the crane element can be less than or equal to 25 kg. It is possible that the ratio of the defined weight of the base to the weight of the crane element is approximately 20:1. This may be the case if the crane element has a height of approximately 2.30 m.

The advantages of the solution according to the invention are that the radially rotatable bearing of the cross arm and the first damping element in combination with the first and further damping element ensures functionally secure handling without the base having to be fixed to an underlying base on its support surface.

The additional further damping element allows, in pulling direction of a holding rope as a flexible sling when the device is in use, a further cushioning of jerky movements in the event of a safety incident and thus contributes to stabilizing the whole device in order to prevent it from falling over, or at least to reduce this risk.

The invention will be explained below in more detail on the basis of an exemplary embodiment, with reference to the drawings. Further advantages, features and embodiments of the invention will be revealed.

### BRIEF DESCRIPTION OF THE DRAWINGS

FIG. 1 shows a schematic representation of the device for height safety and/or protection against falls with base and crane element; and

FIG. 2 shows a schematic representation of an upper region of the crane element.

### DETAILED DESCRIPTION OF THE PREFERRED EMBODIMENTS

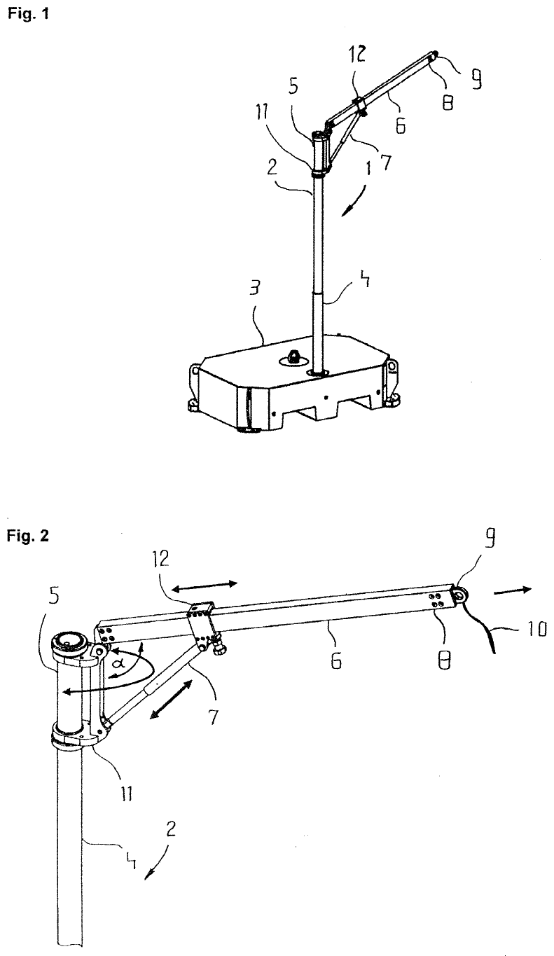

FIG. 1 and FIG. 2 show, in full or in part, the device 1 according to the invention for height safety and/or protecting people against falls. This consists of a mobile davit arm as a crane element 2 having a base 3, which is only shown in FIG. 1. The base 3 is intended to be placed on a support surface, for example horizontal surfaces such as horizontal parts of buildings or temporary platforms such as slab formwork and other scaffolding-like structures.

Furthermore, the base 3 has a defined weight, which in the exemplary embodiment is 500 kg. The base 3 is a cuboid element with a mount in the form of a bush for the crane element 2. The crane element 2 is inserted into the mount in a functionally secure manner. In the exemplary embodiment, it has a weight of 25 kg.

It has an upright rod element 4, at the free end 5 of which a cross arm 6 is arranged to be pivotable at a variable angle α to the rod element 4—pivotable relative to the rod element 4 in a plane. This makes it possible to vary the angle α.

Furthermore, the crane element 2 has a first damping element 7, which is arranged on the rod element 4 and the cross arm 6 so that the first damping element 7 can counteract a supporting movement of the cross arm 6 in the direction of the base 3 and thus also a change in the angle α. In the exemplary embodiment, the damping element consists of two rod-shaped components that are pushed into each other with a press fit and can slide inside one other when pressure is applied, i.e. a support movement of the cross arm 6.

The cross arm 6 and the first damping element 7 are arranged radially rotatably at the free end 5 of the rod element 4 by means of at least one bearing element 11. This allows a rotational movement relative to the rod element 4 about its vertical axis.

According to the invention, a further damping element 9, which can counteract an extension movement or a pulling movement in the longitudinal extension of the cross arm 6, a so-called tension damper, is provided on the cross arm 6 at another free end 8 of the cross arm 6. At least one flexible sling 10, in the exemplary embodiment a holding rope, is arranged on the further damping element 9. A person to be secured can then be attached to the holding rope. The holding rope is therefore used to secure a person against falling.

In the exemplary embodiment, the further damping element 9 is a damper acted upon by spring force. It has an eyelet at its free end to which the holding rope is reversibly attached, as is shown schematically in the exemplary embodiment.

### LIST OF REFERENCE NUMBERS

1. Device
2. Crane element
3. Base
4. Rod element
5. Free end
6. Cross arm
7. First damping element
8. Other free end
9. Further damping element
10. Flexible sling
11. Bearing element
12. Clamping element

1. A device for height safety and/or protecting people against falls, consisting of at least one mobile davit arm as a crane element with a base,
wherein the base has a defined weight for arrangement on a support surface, the crane element has an upright rod element, at the free end of which a cross arm is arranged to be pivotable at a variable angle α to the rod element,
wherein a first damping element is arranged on the rod element and the cross arm such that the first damping element can counteract a support movement of the cross arm in the direction of the base and/or can allow a change in the angle α by means of plastic deformation,
the cross arm and the first damping element are arranged to be radially rotatable by means of at least one bearing in an upper region of the free end of the rod element, and
wherein at another free end of the cross arm a further damping element is arranged on the cross arm, which can counteract an extension movement in the longitudinal extension of the cross arm, and at least one flexible sling can be arranged on the further damping element, to which a person to be secured can be attached.

2. The device according to claim 1, wherein the bearing is a bearing element which has at least one bearing shell and is arranged to be radially rotatable in the upper region of the free end of the rod element, and the cross arm and the first damping element are arranged on the bearing element.

3. The device according to claim 1, wherein the defined weight of the base is many times greater than the weight of the crane element.

4. The device according to claim 1, wherein the base is arranged on the support surface without a form-fitting and/or force-fitting attachment thereto.

5. The device according to claim 1, wherein the first damping element is arranged on the cross arm so as to be axially displaceable.

6. The device according to claim 4, wherein the first damping element is arranged to be axially displaceable on the cross arm by means of a clamping element.

7. The device according to claim 1, wherein the further damping element is integrated into the cross arm.

8. The device according to claim 1, wherein the further damping element includes at least one spring element.

9. The device according to claim 8, wherein the at least one spring element is a coil spring.
